(19) United States
(12) Patent Application Publication
(10) Pub. No.: US 2020/0221165 A1
(43) Pub. Date: Jul. 9, 2020

(54) SYSTEMS AND METHODS FOR EFFICIENT VIDEO CONTENT TRANSITION EFFECTS GENERATION

(71) Applicant: Fedor Losev, Netanya (IL)

(72) Inventor: Fedor Losev, Netanya (IL)

(73) Assignee: NoviSign Ltd, Kfar Saba (IL)

(21) Appl. No.: 16/241,797

(22) Filed: Jan. 7, 2019

(51) Int. Cl. H04N 21/431; G06K 9/00; H04N 21/433

(52) U.S. Cl. CPC H04N 21/4312; H04N 21/4331; H04N 21/4318; G06K 9/00744

(57) ABSTRACT

A system for creating a transition effect between a first composition and a second composition. The system includes one or more processors. The system also includes system memory coupled to the one or more processors, the system memory storing instructions that are executable by the one or more processors and the one or more processors executing the instructions stored in the system memory to approximate a video transition. The instructions include extracting a frame from a first composition as a first image and extracting a frame from a second composition as a second image. The instructions also include constructing a transition effect between the first image and the second image.

### CROSS-REFERENCE TO RELATED APPLICATIONS

Not applicable.

### BACKGROUND OF THE INVENTION

Rendering a series of content compositions is a well-known content presentation technique used in applications mimicking carousel slides such as PowerPoint, digital signage, advertising and other sequential content presenting applications. To improve viewing experience or emphasize a message delivered by the content, the content composition and appearance changes usually incorporate visually smooth transitions between compositions of content elements over time, e.g. cross-fade of subsequent slides in PowerPoint or digital signage boards.

In digital signage or slideshow presentations, the presentation device is a system connected to a local or remote display screen, or embedded in such a screen, or streaming or storing the rendered content in appropriate format to display on the screen, such as video corresponding to the presentation content.

The rendered content at every point of time usually includes, but is not restricted to, video, animated images, text, and geometric shape elements. The intervals between content compositions changes and particular content appearance scheduling on the screen may be automatic, as specified by a system configuration or a content management system (CMS), or they may be manually controlled by a presenter or interactively by the viewer.

Some examples of such systems are low and mid-end devices, such as inexpensive computer sticks, embedded devices, and mobile-chipset based presentation systems usually used in digital signage deployments. On such devices, the decoding pipeline is tightly connected to the rendering pipeline in the hardware, the operating system or both, making it impossible to perform smooth transformations on all or selected sections of multiple videos, thus preventing most practical cases of smooth visual transition between video elements or between video and other types of elements.

A practical example is a broad range of low-end, inexpensive computing sticks and boxes running the Android operating system on a mobile chipset hardware with integrated graphics and a video decoding pipeline. On many of these systems, all or part of the above challenges are present: the pipeline producing a black rectangle before frame appearance and/or not allowing opacity changes (required for fade transitions), and/or not allowing non-isometric geometry transformations (required for transition effects such as folding, skew, 3D projections). On some devices the only feasible transformation is 2D rectangle translation, restricting the transition effects to sliding. On some systems, even coordinate translation of real-time rendered video is not smooth compared to image translations.

Thus, video manipulation is severely limited or not possible on many low-cost Android-based computing devices, embedded or attached to a screen, vending machines embedded chipsets, or low-end tablet devices.

Another related challenge on such devices is side-production by the rendering pipeline of undesired visual artifacts, for example, “black flash” on video start. Some chipset/OS implementation combinations render a visible black or colored rectangle before presenting the first visible video frame (filling zeros at random before enough frames are decoded), appearing as a “flash” during video transition and some produce this or other visual artifacts even at the time of video stop/removal from the content even when the video element is hidden. In addition, video rendering start on most systems requires some finite amount of time, producing a delay in a perceived displayed sequence while the decoding/rendering is started by the underlying OS/hardware.

On many devices, it is also only possible to decode, process and render efficiently a small number of videos simultaneously, because of limited dedicated hardware video decoder resources and infeasibility of decoding and processing video on low-end CPUs. When the content which is involved in a transition contains more videos than the device can render (sometimes limited to single video only), no transition between playing videos is possible. For another example of challenges, on server-generated content stream, decoding and manipulating videos for a transition have a high cost compared to manipulating a small number of images.

For example, transition by video manipulation from a content containing two videos to a content containing another two videos will require simultaneous processing and rendering of four videos, which in the case of HD video is beyond the capability of many low-end devices and even in a capable environment has a high cost.

Known content presentation implementations produce smooth transitions by manipulating element color and geometry properties of the playing video. As a result, they do not address the described limitations of constrained devices and cannot produce on such devices smooth transitions between content involving videos with controllable effects. As well, they do not address video transition rendering costs, requiring decoding and rendering of all involved videos.

Accordingly, there is a need in the art for systems and methods that create a transition without requiring video playback rendering.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for creating a transition effect between a first composition and a second composition. The system includes one or more processors. The system also includes system memory coupled to the one or more processors, the system memory storing instructions that are executable by the one or more processors and the one or more processors executing the instructions stored in the system memory to approximate a video transition. The instructions include extracting a frame from a first composition as a first image and extracting a frame from a second composition as a second image. The instructions also include constructing a transition effect between the first image and the second image.

Another example embodiment includes a system for creating a transition effect between a first composition and a second composition. The system includes one or more processors. The system also includes system memory coupled to the one or more processors, the system memory storing instructions that are executable by the one or more processors and the one or more processors executing the instructions stored in the system memory to approximate a video transition. The instructions include displaying a first composition. Displaying the first composition includes rendering the first composition, wherein rendering the first composition includes processing stored information in the first composition to produce a series of images and presenting the series of images in order on a monitor. The instructions also include creating a transition. Creating the transition includes extracting a frame from the first composition as a first image and extracting a frame from a second composition as a second image. Creating the transition also includes constructing a transition effect between the first image and the second image. The instructions further include displaying the transition after displaying the first composition. Displaying the transition includes presenting the transition on a monitor. The instructions additionally include displaying the second composition after displaying the transition. Displaying the second composition includes rendering the second composition, wherein rendering the second composition includes processing stored information in the second composition to produce a series of images. Displaying the second composition includes presenting the series of images in order on a monitor.

Another example embodiment includes a system for creating a transition effect between a first composition and a second composition. The system includes one or more processors. The system also includes system memory coupled to the one or more processors, the system memory storing instructions that are executable by the one or more processors and the one or more processors executing the instructions stored in the system memory to approximate a video transition. The instructions include displaying a first composition. Displaying the first composition includes rendering the first composition, wherein rendering the first composition includes processing stored information in the first composition to produce a series of images and associated audio data and presenting the rendered first composition on a monitor. The instructions also include creating a transition. Creating the transition includes extracting a frame from the first composition as a first image and extracting a frame from a second composition as a second image. Creating the transition also includes constructing a transition effect between the first image and the second image. The instructions further include displaying the transition immediately after displaying the first composition. Displaying the transition includes rendering the transition at the coordinates and dimension of the first composition and presenting the transition on a monitor. The instructions additionally include displaying the second composition immediately after displaying the transition. Displaying the second composition includes rendering the second composition, wherein rendering the second composition includes rendering the second composition at the coordinates and dimension of the transition and processing stored information in the second composition to produce a series of images and associated audio data. Displaying the second composition includes presenting the rendered second composition on a monitor.

These and other objects and features of the present invention will become more fully apparent from the following description and appended claims or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of creating a transition effect;

FIG. 2 is a flowchart illustrating a method for displaying a first composition and a second composition with a transaction between the first composition and the second composition;

FIG. 3 Shows a transition on the timeline of an image slide turning into another image slide through a process;

FIG. 4 Demonstrates a video frame image extraction: the last image from the first video and the first image from the following video;

FIG. 5 Elaborates the full process of how a transition takes places using the invention; and

FIG. 6 illustrates an example of a suitable computing environment in which the invention may be implemented

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

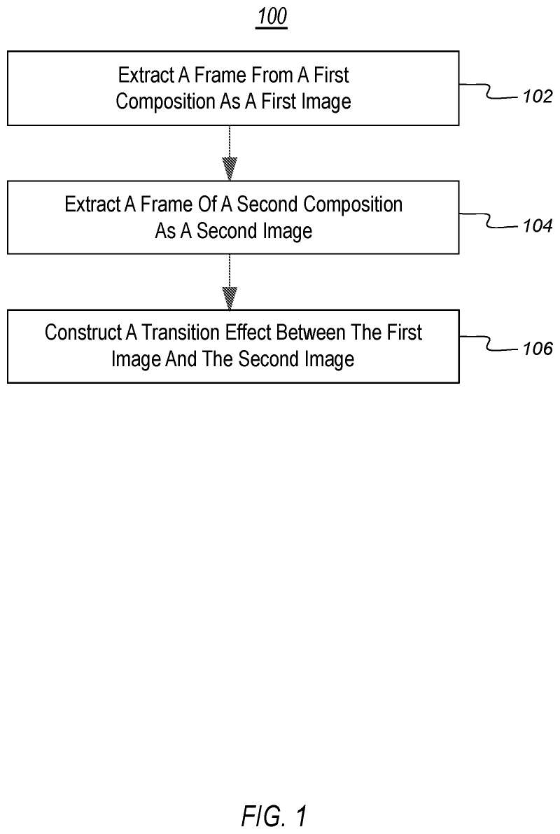

FIG. 1 is a flowchart illustrating a method 100 of creating a transition effect. The method 100 provides an efficient way to approximate transitions when they involve video elements without actually rendering video under transition. Approximating a transition saves computing resources, which is critical considering that the computing resources are normally used to a large extent to render and show the video elements, leaving few resources for transitions.

FIG. 1 shows that the method 100 can include extracting 102 a frame from a first composition as a first image. The first composition can include any desired video elements. I.e., the first composition is a series of still images that, when shown on a screen, create the illusion of moving images along with related components, such as audio data. For example, the video element can include, but is not limited to, a film, a movie, a motion picture, a moving picture, a theatrical film, a photoplay, a slide show, or any other image presentation.

In filmmaking, video production, animation, and related fields, a frame is one of the many still images which compose the complete moving picture along with additional related data. When the moving picture is displayed, each frame is flashed on a screen for a short time (nowadays, usually 1/24, 1/25 or 1/30 of a second) and then immediately replaced by the next one. Persistence of vision blends the frames together, producing the illusion of a moving image. Typically, the chosen frame will be the last frame; however, this does not have to be the case. In general, choosing the last frame of the first composition gives the appearance to a watcher that the first composition ends, followed immediately by the transition (i.e., the first composition and the transition blend seamlessly into one another).

Extracting 102 a frame from the first composition includes striping away any non-visual elements and producing the image from stored data. For example, any audio data or other related data is removed such that the only remaining data is some or all of the visual data from the last frame. In some cases, some visual data is also removed. For example, background can be removed, the visual data can be cropped, etc.

One of skill in the art will appreciate that more than one frame may be chosen. For example, if the transition is going to take exactly one second, then all of the frames which constitute the final second of the first composition can have images extracted 102. Thus, the transition may appear to be the final segment of the first composition, even though all associated non-visual data has been stripped.

FIG. 1 also shows that the method 100 can include extracting 104 a frame of a second composition as a second image. The second composition can include the first composition (e.g., if being played on repeat) or a different composition, which will be the normal case. The extracted 104 frame will normally be the first frame of the second composition but need no be. Likewise, more than one frame may be extracted 104 and can, but does not have to, match the number of frames extracted 102 from the first composition.

Depending on the desired transition effect and elements involved, just one image may be sufficient. For example, to visually approximate the common case of cross-fade between video elements of the same geometry, it may be enough to fade-in the second image over the first image, removing the first image once the second image reaches zero opacity and is obscuring the first image. Thus, a transition effect that approximates a cross-fade may require only a single frame from the first composition and a single frame from the second composition.

In accordance with the present invention, only a few still images corresponding to the video frames at the desired transition start and end time points are produced, usually for the first and last frame of displayed video sequences. These images may be extracted in advance or in the background and are used in place of video to simulate time-evolving visual or geometric transformations between a new composition and an old composition and/or when any composition begins or ends, even if the composition is the first or last composition (which may obscure possible visual artifacts of video start and stop). Hence, it eliminates the shortcomings and disadvantages of the prior art mentioned above.

FIG. 1 further shows that the method 100 can include constructing 106 a transition effect between the first image and the second image. The transition effect includes any visual transition between the first image and the second image. To improve the viewer experience or emphasize a message delivered by the content, the content composition, and appearance changes usually incorporate transitions between the appearance over time. A screen content at some time point may change to a different content at the next time point. Instead of making a change perceived by the viewer as instant, the system will make gradual changes to the appearance of both elements, creating a perception of dynamic morphing between content.

The transitions usually include, but are not restricted to, a combination of transformations of pixel or area color, opacity or geometry of content elements over time, such as fade, pan, zoom, rotation, translucent masking, etc. For example, in cross-fade transition, opacity of the first image will decrease over time, opacity of the second image will increase over time, producing an effect of old content smoothly becoming new content.

Manipulating visual properties of rendered content over time, such as opacity or geometry is commonly used to produce visual transitions between content items, with a broad range of controllable visual effects. However, creating smooth, visually appealing transitions consisting of dynamic transformations of a shape, color, opacity or other visual properties of multiple elements or parts of them over time, presents a challenge for video elements on a broad class of presentation systems where video decoding capabilities or rendering resources are constrained. Therefore, the complexity, and computing resources, is reduced by creating a transition between the first image and the second image.

One skilled in the art will appreciate that the transition effect can be produced for a single extracted image. For example, for a beginning transition, on video start the start time frame still image is presented on the screen and a combination of start transformations is performed to create the desired visual effect, such as fade-in, over time. The transition effect can be a transition from an image all of a single color (such as an image with all black pixels or all white pixels, etc.), or from the background currently on the screen. Hence, no visual transformations on rendered or currently rendering video are required. Once the start transformation is finished and the image is positioned in the place of the video, the video rendering is started below the frame image in visual order.

The image obscures, from a viewer's standpoint, any artifacts related to the video rendering start until the video is initialized and properly rendered, including the delay of video initialization. Once the first frame of the played video is detected (or predicted) to be rendered, the image is removed from displayed content, and subsequent frames of the video appear on the screen as usual, producing a continuous extension of the frame sequence from the first frame presented by the still image.

Similarly, when the video is nearing a frame corresponding to stop time (i.e., when the final composition is being played), the end frame image is positioned above the video content as a continuation of the frame sequence, the video is removed from displayed content and finish transformations are performed on the image to produce the desired visual effect, such as fade-out, over time.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

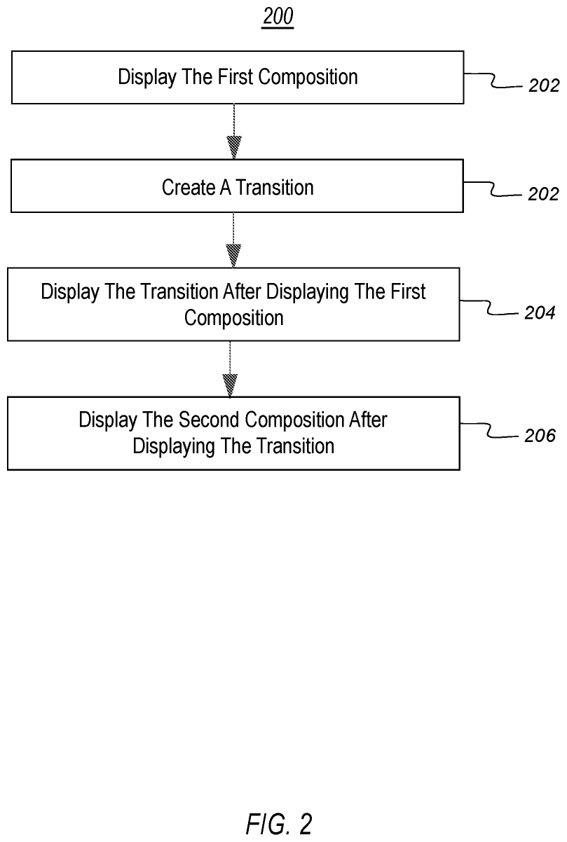

FIG. 2 is a flowchart illustrating a method 200 for displaying a first composition and a second composition with a transaction between the first composition and the second composition. One of skill in the art will appreciate that the goal is to present a transition that is visibly pleasing to a viewer without requiring massive computing resources that would create visually displeasing artifacts, such as pauses, etc. I.e., a transition is a visual transition between the first composition and the second composition that doesn't require rendering or requires only a partial rendering.

FIG. 2 shows that the method 200 can include displaying 202 the first composition. Displaying 202 the first composition can include preparing the first composition to be shown to a user. I.e., displaying 202 the first composition includes preparing a stream of data such that audio and visual components, and any other relevant components, can be played and observed by a user.

In order to display 202 the first composition, the first composition must be rendered. Video rendering is the process by which a computer processes information from a coded data source and uses that information to produce and display an image or video composition. The computer code may include instructions on creating images verbatim for playing back a movie or may provide a set of guidelines the computer uses to generate a custom image like a webpage. Video rendering can be one of the most hardware-demanding processes for a computer, especially when it's done in real time.

Whatever a computer displays on the screen is rendered in real time: The computer is computing all the coded data fast enough to display and update images with no perceivable lag. However, the computer can only render so much content complexity at once to continue the real-time rendering perception. The term rendering is used in video editing and processing to describe the computer taking extra time to render graphics and generate a full-motion-video playback version that works in real time. For example, a computer animated movie features models that are too complicated for the computer to generate in real time, so the computer renders the content in advance, so it can later be viewed in real time.

The computer's processor doesn't go at video rendering alone. Graphics processing units, or GPUs, are a hardware counterpart to computer central processing units, or CPUs, that are much better suited for handling video rending complexities. CPUs are designed to handle large tasks very quickly one at a time, whereas GPUs are designed to handle dozens to thousands of small tasks simultaneously. Video rendering is a series of small tasks, making the GPU substantially better suited for the task.

In addition, displaying 202 the first composition includes at least presenting the series of images, including any associated data, in order on a monitor. A monitor is any screen that displays images; for example, images generated by a computer. In addition, a monitor can include other electronic components, such as speakers, which present content to a user. For example, a monitor can include a display, a television, etc. which can display images.

FIG. 2 also shows that the method 200 can include creating 204 a transition. The transition can be created 204 using the method 100 of FIG. 1 or any other desired method. The transition 204 can be created before the first composition is displayed 202, while the first composition is displayed 202, or can be created in real-time (i.e., immediately after the first composition is displayed 202).

FIG. 2 further shows that the method 200 can include displaying 206 the transition after displaying the first composition. I.e., the ideal scenario is that immediately after the ending of the first composition (i.e., with only a time delay of a single frame based on the frame rate) the transition is presented on a monitor. Thus, from a viewer's perspective there is no pause between the end of the presentation of the first composition and the beginning of the transition.

The simultaneous transformations of start and stop images produce the approximation of the desired transition transformation of the video over time, for example, cross-fade. When rendering transitions between complex content involving different elements such as images, video, and text, multiple images corresponding to each video are used, eliminating the need for multiple simultaneous video renderings during a transition.

FIG. 2 additionally shows that the method 200 can include displaying 208 the second composition after displaying the transition. Displaying 208 the second composition is the same as displaying 202 the first composition. As above, the ideal scenario is that immediately after the ending of the transition (i.e., with only a time delay of a single frame based on the frame rate) the second composition is presented on a monitor. Thus, from a viewer's perspective there is no pause between the end of the transition and the presentation of the second composition.

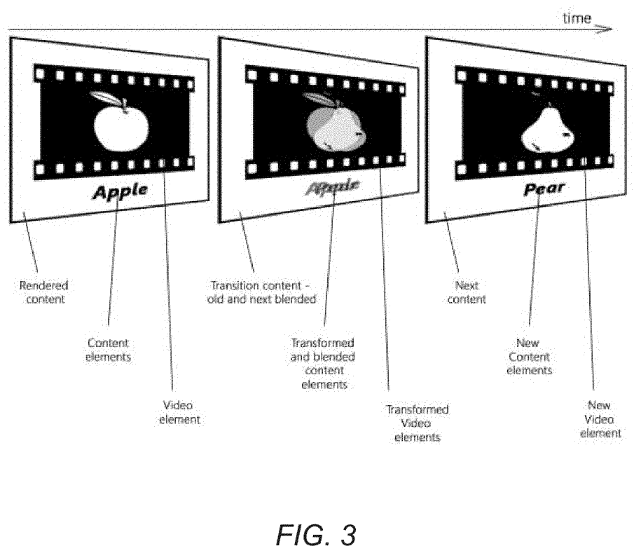

FIG. 3 illustrates an example of creating a transition effect 300 between a first composition and a second composition. The transition effect approximates a fully rendered transition between the first composition and the second composition. I.e., from a viewer's standpoint, there is little or no visual difference between a fully rendered transition and the approximation.

FIG. 3 shows that the first composition 302, including video elements, is rendered at some point in time and a second composition 304 is rendered later in time, replacing the first composition 302 on the screen. A presentation system is producing a visual transition 306 between elements over time by rendering one or more images extracted from the first composition 302 and the second composition 304 and applying separate color or geometry transformations over time to each and rendering the blended content as a transition effect, as illustrated by the example in FIG. 3.

The first composition 302 may be a sub-interval of a whole video. In this case, first and last frames of the first composition and the second composition mentioned in steps below correspond to the first and last frames of the played/rendered video sequence inside the first composition 302 and the second composition 304 and not necessary the first and the last frames of the video medium. The timestamp of the first and last frames may be calculated from slide duration and desired video start frame (for an offline generation as detailed below) or alternatively deduced de-facto from the playing video inside the slide (online/dynamic generation as detailed below).

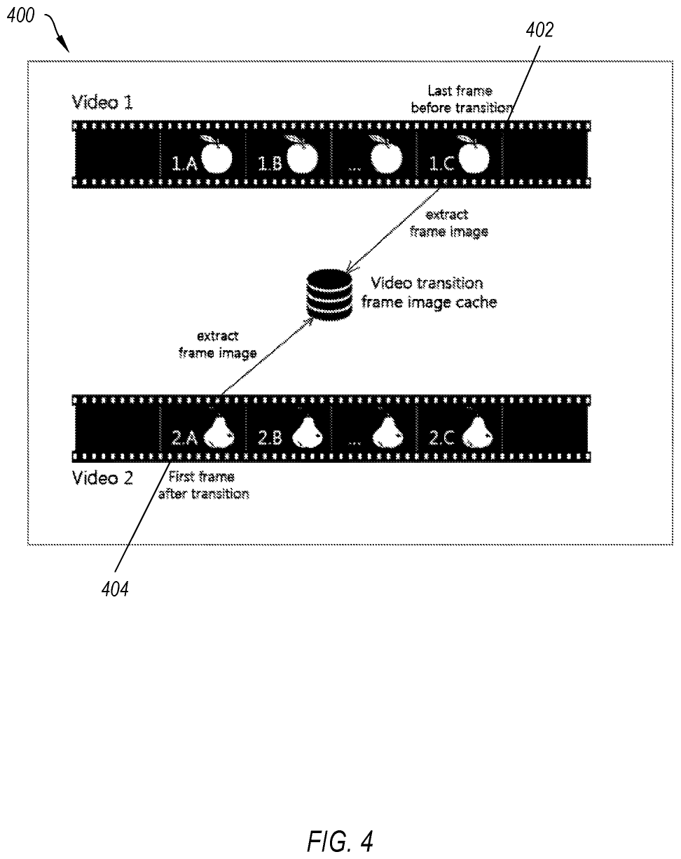

FIG. 4 illustrates an example of image extraction 400 from a first composition and a second composition. Image extraction includes pulling all visual data from a frame, without pulling any associated data, such as audio data. Thus, what is left to be rendered and displayed on a monitor is an image, rather than a fully rendered video.

FIG. 4 shows that the frame image extraction may be done with an offline process, by decoding the corresponding first composition frame 402 and second composition frame 404 in advance, before playing any compositions. All frame images required for transitions are extracted and kept in a cache. This may be done on the same system but also includes a possibility of running such a process on a separate host or centralized server. The extraction can be performed using an OS supplied decoder (for example Windows/DirectShow/MF, Android MediaCodec or another system API), a decoding library (e.g. FFmpeg), embedded software decoder or by other means.

For offline preparation to work, the first composition frame 402 and second composition frame 404 positions inside the second composition and the first composition, respectively, must be known or be calculated in advance. Alternatively, the frame image can be generated and cached on demand at the time of slide rendering. For example, when frame positions at the transition time are not known in advance.

When generating a sequence not in real-time, for example by server-side generation, the first composition frame 402 and second composition frame 404 may use already decoded frame images, by keeping the first and last rendered video frames in a cache and rendering a transition after both slides content rendering.

When generating transitions in real-time, for the first composition, a snapshot may be used of the already rendered first composition frame 404 (however, this is not always possible). For example, on some hardware/OS combinations where the video decoder is tightly coupled with GPU rendering pipeline, it is not possible to acquire directly the image snapshot of the video frame currently playing on the screen, so this would not work.

For the second composition and/or first composition when a frame snapshot is not available, a separate decoding routine is used to extract the image, similar to the before mentioned offline preparation. Unlike offline preparation, on-demand generation still allows dynamic video end time, not known in advance, per recurrent appearance of the same slide, because the required video frame index can be calculated exactly from the playing video position.

Sometimes it is not feasible to perform fast video decoding of the desired frame at transition time, because complete video must be decoded from the nearest keyframe and this may be computationally expensive for long duration compressed videos. In this case, a background decoding process without rendering may be started. The process will advance decoding in sync with the played video until transition, thus spreading computations over time and reaching the desired frame at the same time as the video.

The latter approach will not reduce the number of simultaneously playing videos but still allow transition approximation, overcoming video manipulation limitations. Further, for not known in advance, but constant transition frame time (over recurrent composition playback), this process needs to be done only once in the first round of recurrent sequence rendering; subsequent transition rendering can use cached images as with the offline process. The background frame decoding process also can be made much less expensive than full decoding for rendering, by decoding from the nearest keyframe and not video start, skipping unnecessary frames, audio data and so forth.

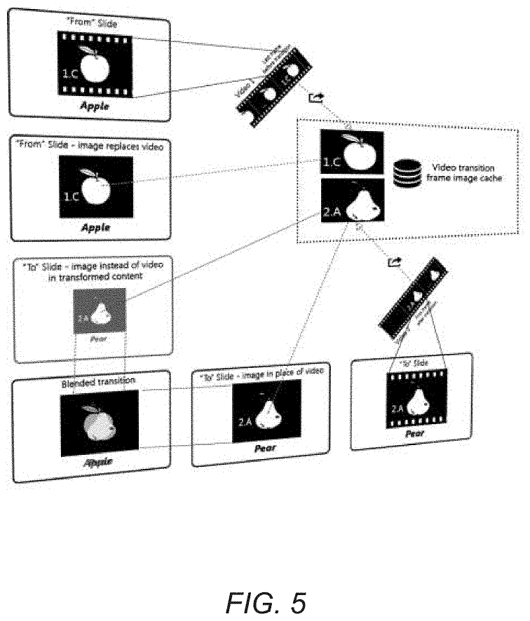

FIG. 5 shows an example of placing a transition 306 between a first composition 302 and a second composition 304 500. The transition 306 appears to a user to be a full transition 306 between the first composition 302 and the second composition 304. The transition 306 plays immediately after the first composition 302 and the second composition 304 begins immediately after the transition 306.

FIG. 5 shows that before a transition 306 start, the generated first image 502 is rendered at the first composition 302 coordinates and dimension. That is, the first image 502 is prepared such that it will match the dimensions and position of the final frame of the first composition 302, so that the user sees no difference between the dimensions and position of the first composition 302 and the second composition 304. Likewise, and simultaneously when possible, the second image 504 is rendered at the same position and dimension.

FIG. 5 also shows that during the transition 306, the color and geometry transformations over time are applied to the first and second image 504s in the same way as if they were applied to the first composition 302 and the second composition 304. For example, during the simple fade-in transition the first image 502 opacity starts at full opacity when the transition 306 begins and decreases to zero during the transition period and the second image 504 opacity starts with zero when the transition 306 begins and increases to full opacity during the transition period.

FIG. 5 further shows that at the end of the first composition 302, the transition 306 is placed in the exact same position and geometry as the first composition 302. Once the first composition 302 ends, the transition 306 begins play immediately (as defined above) and the first composition 302 is removed. When the transition 306 finishes, the second composition 304 is placed in the exact same position and as the transition 306 and immediately (as defined above) initialized and the transition 306 is removed.

One of skill in the art will appreciate that if there is no first composition 302 (i.e., a transition 306 is needed to begin before the first composition 302 is playing then the transition 306 can be from a blank image or from any other desired starting point. E.g., the transition 306 can be from a background that is at the position of the first composition 302.

For example, an approximation of cross-fade into the first composition 302 can be accomplished by merely fading-in of the first image 502. In this case, the opacity of the first image 502 will increase until completely obscuring the background, producing the visual appearance of a fading-in first composition 302. At the transition 306 end, the background or blank image is not visible (because it obscured by the first image 502) and can be removed. Thus, a fade-in transition is approximated.

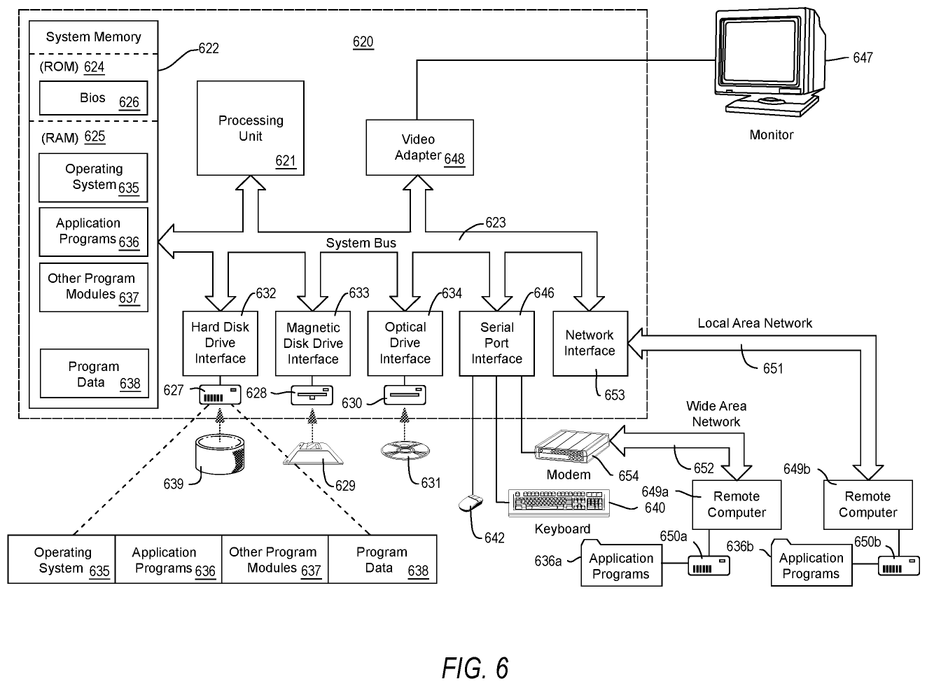

With reference to FIG. 6, an example system for implementing the invention includes a general purpose computing device in the form of a conventional computer 620, including a processing unit 621, a system memory 622, and a system bus 623 that couples various system components including the system memory 622 to the processing unit 621. It should be noted however, that as mobile phones become more sophisticated, mobile phones are beginning to incorporate many of the components illustrated for conventional computer 620. Accordingly, with relatively minor adjustments, mostly with respect to input/output devices, the description of conventional computer 620 applies equally to mobile phones. The system bus 623 may be any of several types of bus structures including a memory bus or memory controller, a peripheral bus, and a local bus using any of a variety of bus architectures. The system memory includes read only memory (ROM) 624 and random access memory (RAM) 625. A basic input/output system (BIOS) 626, containing the basic routines that help transfer information between elements within the computer 620, such as during start-up, may be stored in ROM 624.

The computer 620 may also include a magnetic hard disk drive 627 for reading from and writing to a magnetic hard disk 639, a magnetic disk drive 628 for reading from or writing to a removable magnetic disk 629, and an optical disc drive 630 for reading from or writing to removable optical disc 631 such as a CD-ROM or other optical media. The magnetic hard disk drive 627, magnetic disk drive 628, and optical disc drive 630 are connected to the system bus 623 by a hard disk drive interface 632, a magnetic disk drive-interface 633, and an optical drive interface 634, respectively. The drives and their associated computer-readable media provide nonvolatile storage of computer-executable instructions, data structures, program modules and other data for the computer 620. Although the exemplary environment described herein employs a magnetic hard disk 639, a removable magnetic disk 629 and a removable optical disc 631, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 639, magnetic disk 629, optical disc 631, ROM 624 or RAM 625, including an operating system 635, one or more application programs 636, other program modules 637, and program data 638. A user may enter commands and information into the computer 620 through keyboard 640, pointing device 642, or other input devices (not shown), such as a microphone, joy stick, game pad, satellite dish, scanner, motion detectors or the like. These and other input devices are often connected to the processing unit 621 through a serial port interface 646 coupled to system bus 623. Alternatively, the input devices may be connected by other interfaces, such as a parallel port, a game port or a universal serial bus (USB). A monitor 647 or another display device is also connected to system bus 623 via an interface, such as video adapter 648. In addition to the monitor, personal computers typically include other peripheral output devices (not shown), such as speakers and printers.

The computer 620 may operate in a networked environment using logical connections to one or more remote computers, such as remote computers 649a and 649b. Remote computers 649a and 649b may each be another personal computer, a server, a router, a network PC, a peer device or other common network node, and typically include many or all of the elements described above relative to the computer 620, although only memory storage devices 650a and 650b and their associated application programs 636a and 636b have been illustrated in FIG. 6. The logical connections depicted in FIG. 6 include a local area network (LAN) 651 and a wide area network (WAN) 652 that are presented here by way of example and not limitation. Such networking environments are commonplace in office-wide or enterprise-wide computer networks, intranets and the Internet.

When used in a LAN networking environment, the computer 620 can be connected to the local network 651 through a network interface or adapter 653. When used in a WAN networking environment, the computer 620 may include a modem 654, a wireless link, or other means for establishing communications over the wide area network 652, such as the Internet. The modem 654, which may be internal or external, is connected to the system bus 623 via the serial port interface 646. In a networked environment, program modules depicted relative to the computer 620, or portions thereof, may be stored in the remote memory storage device. It will be appreciated that the network connections shown are exemplary and other means of establishing communications over wide area network 652 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for creating a transition effect between a first composition and a second composition, the system comprising:
one or more processors; and
system memory coupled to the one or more processors, the system memory storing instructions that are executable by the one or more processors;
the one or more processors executing the instructions stored in the system memory to approximate a video transition, including the following:
extracting a frame from a first composition as a first image;
extracting a frame from a second composition as a second image; and
constructing a transition effect between the first image and the second image.

2. The system of claim 1, further comprising:
rendering the transition effect as a video.

3. The system of claim 1, wherein the first composition includes a video.

4. The system of claim 1, wherein the first composition includes a slide show.

5. The system of claim 1, wherein the frame from the first composition is the last frame in the first composition.

6. The system of claim 1, wherein the frame from the second composition is the first frame in the second composition.

7. A system for creating a transition effect between a first composition and a second composition, the system comprising:
one or more processors; and
system memory coupled to the one or more processors, the system memory storing instructions that are executable by the one or more processors;
the one or more processors executing the instructions stored in the system memory to approximate a video transition, including the following:
displaying a first composition, wherein displaying the first composition includes:
rendering the first composition, wherein rendering the first composition includes processing stored information in the first composition to produce a series of images; and
presenting the series of images in order on a monitor;
creating a transition, wherein creating the transition includes:
extracting a frame from the first composition as a first image;
extracting a frame from a second composition as a second image; and
constructing a transition effect between the first image and the second image;
displaying the transition after displaying the first composition, wherein displaying the transition includes presenting the transition on a monitor; and
displaying the second composition after displaying the transition, wherein displaying the second composition includes:
rendering the second composition, wherein rendering the second composition includes processing stored information in the second composition to produce a series of images; and
presenting the series of images in order on a monitor.

8. The system of claim 7, wherein the transition effect includes:
a change in opacity of the first image over time.

9. The system of claim 7, wherein the transition effect includes:
a change in geometry of the first image over time.

10. The system of claim 7, wherein the transition effect includes:
fade.

11. The system of claim 7, wherein the transition effect includes:
pan.

12. The system of claim 7, wherein the transition effect includes:
zoom.

13. The system of claim 7, wherein the transition effect includes:
rotation.

14. The system of claim 7, wherein the transition effect includes:
translucent masking.

15. A system for creating a transition effect between a first composition and a second composition, the system comprising:
one or more processors; and
system memory coupled to the one or more processors, the system memory storing instructions that are executable by the one or more processors;
the one or more processors executing the instructions stored in the system memory to approximate a video transition, including the following:
displaying a first composition, wherein displaying the first composition includes:
rendering the first composition, wherein rendering the first composition includes processing stored information in the first composition to produce a series of images and associated audio data;
presenting the rendered first composition on a monitor;
creating a transition, wherein creating the transition includes:
extracting a frame from the first composition as a first image;
extracting a frame from a second composition as a second image; and
constructing a transition effect between the first image and the second image;
displaying the transition immediately after displaying the first composition, wherein displaying the transition includes:
rendering the transition at the coordinates and dimension of the first composition; and
presenting the transition on a monitor;
displaying the second composition immediately after displaying the transition, wherein displaying the second composition includes:
rendering the second composition, wherein rendering the second composition includes:
rendering the second composition at the coordinates and dimension of the transition; and
processing stored information in the second composition to produce a series of images and associated audio data;
presenting the rendered second composition on a monitor.

16. The system of claim 15, further comprising:
extracting a second frame from the first composition; and
constructing a start transition effect.

17. The system of claim 16, wherein the second frame is the first frame in the first composition.

18. The system of claim 15, further comprising:
extracting a second frame from the second composition; and
constructing an end transition effect.

19. The system of claim 18, wherein the second frame is the last frame in the second composition.

20. The system of claim 15, further comprising:
caching the first image and the second image prior to constructing the transition effect.
